(19) United States
(12) Patent Application Publication
(10) Pub. No.: US 2008/0073332 A1
(43) Pub. Date: Mar. 27, 2008

(54) DUAL HEAD SOLDERING DEVICE

(76) Inventor: Phillip J. Racheter, Fostoria, OH (US)

Correspondence Address: FRASER CLEMENS MARTIN & MILLER LLC, 28366 KENSINGTON LANE, PERRYSBURG, OH, 43551, US

(21) Appl. No.: 11/858,185

(22) Filed: Sep. 20, 2007

Related U.S. Application Data
(60) Provisional application No. 60/846,299, filed on Sep. 21, 2006.

(51) Int. Cl. B23K 3/04

(52) U.S. Cl. 219/230

(57) ABSTRACT

The present invention relates to a soldering device for joining two work pieces and more specifically, a soldering device with two cooperating spring biased jaws adapted to grip a work piece to be joined to a second work piece to uniformly apply heat energy to the work pieces, and reduce the risk of burning and melting items adjacent to the work pieces.

### CROSS-REFERENCE TO RELATED APPLICATION

This application claims the benefit of U.S. Provisional Patent Application Ser. No. 60/846,299 filed on Sep. 21, 2006.

### FIELD OF THE INVENTION

The present invention relates to a soldering device for joining two work pieces. More specifically, the invention relates to a soldering device with two cooperating spring biased jaws adapted to clamp to the respective ends of two work pieces such as pipes, pipe fittings, and fixtures to be joined.

### BACKGROUND OF THE INVENTION

The soldering of work pieces such as pipes, pipe fittings, and fixtures is typically accomplished by using a single flame gas torch. The torch is utilized to supply sufficient heat energy to the pipe joint to melt applied solder and cause the molten solder to be drawn into the joint by capillary action. A single torch requires the user to provide relative movement between the torch and the work pieces to be joined to ensure that the entire circumference of the pipe joint has sufficient heat energy to cause the molten solder to flow and form a leak free joint. Holding the torch and providing the relative motion between the torch and the work piece is a source of fatigue for the user.

In many instances, the joint to be formed between the work pieces is located adjacent to other objects rendering it difficult to apply the flame uniformly around the intended joint. Further, the items such as wood, insulation, or plastic adjacent to the pipe joint are often flammable and could be damaged by the flame of the torch.

It would be desirable to produce a device attachable to a work piece to uniformly deliver heat energy to the work piece, and reduce the risk of burning and melting adjacent items.

### SUMMARY OF THE INVENTION

Compatible and attuned with the present invention, a device attachable to a work piece to uniformly deliver heat energy to the work piece, and reduce the risk of burning and melting adjacent items, has surprisingly been discovered.

The above objectives and advantages of the invention are achieved by a heating device for applying heat energy to the end of two work pieces to be joined comprises a pair of connected relatively moveable jaws, each of the jaws having a work piece gripping surface; spring means normally maintaining the gripping surfaces in a work piece gripping position; and means for delivering heat energy adjacent to the cooperating work piece gripping surfaces.

In another embodiment, a heating device for applying heat energy to the end of two work pieces to be joined comprises a first jaw pivotally connected to a second jaw, the jaws cooperating to form a generally circular shaped first gripping surface and a spaced apart generally circular shaped second gripping surface, the gripping surfaces forming a substantially annular channel therebetween; an elongate compression spring disposed between the jaws adjacent the location where the jaws are pivotally connected, the spring adapted to maintain the gripping surfaces in a work piece gripping position; and a fluid communication path from a source of flammable gas, through the second jaw, and into the channel formed between the first gripping surface and the second gripping surface, wherein the flammable gas is caused to burn adjacent the gripping surfaces to supply heat energy to the work pieces to be joined.

### BRIEF DESCRIPTION OF THE DRAWINGS

The above, as well as other advantages of the invention will become readily apparent to one skilled in the art from reading the following detailed description of a preferred embodiment of the invention when considered in the light of the accompanying drawings, in which:

FIG. 1 is a perspective view of one side of a soldering device embodying the features of the present invention, showing the clamping jaws of the device in a normally closed position;

FIG. 2 is a perspective view of the opposite side of the soldering device shown in FIG. 1; and

FIG. 3 is an exploded perspective view partially in section of the soldering device shown in FIG. 1.

### DETAILED DESCRIPTION OF THE PREFERRED EMBODIMENT OF THE INVENTION

The following detailed description and appended drawings describe and illustrate an exemplary embodiment of the invention. The description and drawings serve to enable one skilled in the art to make and use the invention, and are not intended to limit the scope of the invention in any manner.

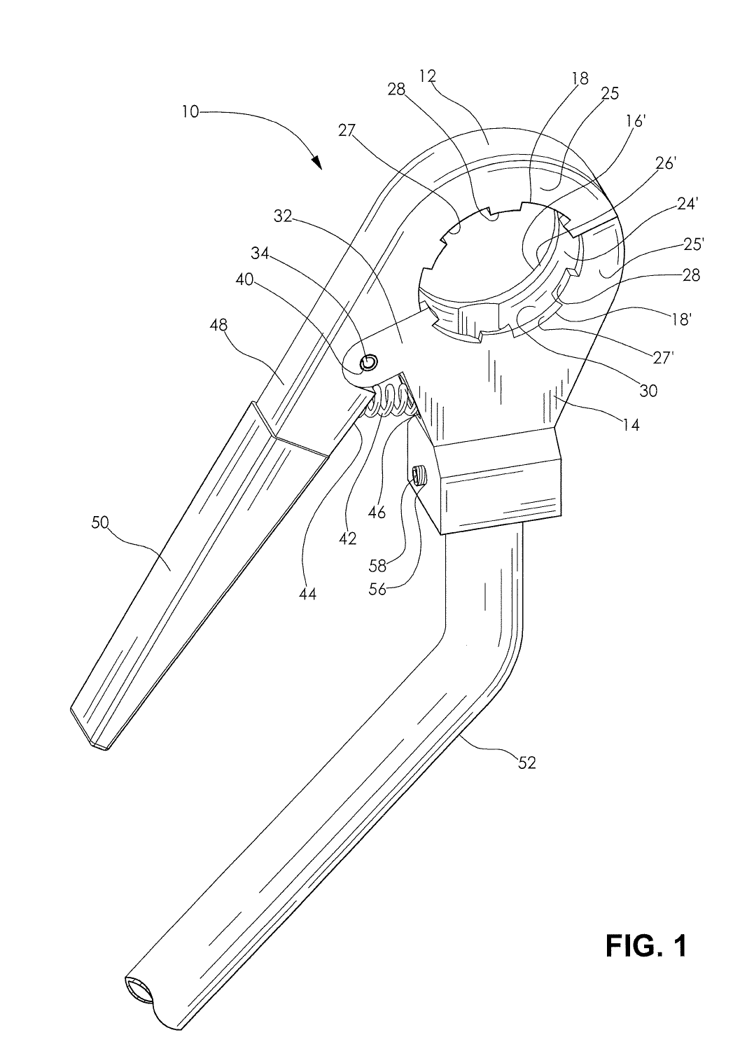

Referring to the drawings, there is illustrated in FIGS. 1, 2, and 3 a soldering device, generally indicated by reference numeral 10. The soldering device is adapted to attach to a work piece being joined to another work piece, and uniformly deliver heat energy to the ends of the work pieces while reducing the risk of burning and melting items adjacent to the work pieces.

The soldering device 10 has a pair of pivotally interconnected jaws 12 and 14. The jaws 12, 14 have a first gripping surface 16, 16′ and a spaced apart second gripping surface 18, 18′ for securely gripping the work piece between the jaws 12, 14. The first gripping surface 16, 16′ and the spaced apart second gripping surface 18, 18′ form an annular channel 30 therebetween when the jaws 12, 14 are in a closed or a work piece gripping position. The jaws 12, 14 may be formed from a metallic material or other material with thermal properties capable of withstanding the heat energy necessary to solder work pieces together.

When the jaws 12, 14 are in a closed position, the general shape of the gripping surfaces 16, 16′ and 18, 18′ match the shape of the outer periphery of the work pieces being joined. The first gripping surface 16, 16′ and the second gripping surface 18, 18′ each form a substantially circular shape to retain a cylindrical work piece such as a pipe or pipe coupling, for example. The diameter of the circular shape formed by the gripping surfaces 16, 16′ and 18, 18′ is selected to substantially match the outside diameter of the work pieces to be gripped. Different sized jaws 12, 14 may be used for soldering work pieces of different outside diameters. It should be understood that the gripping surfaces 16, 16′ and 18, 18′ can be adapted to form other shapes such as an oval or a rectangle, for example.

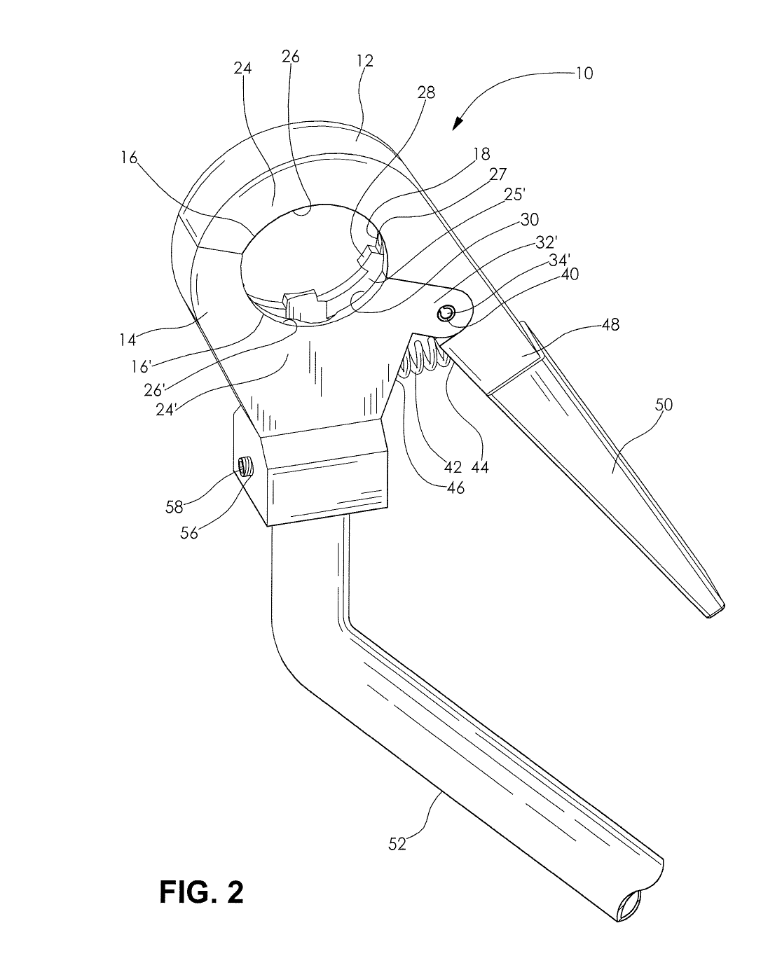

The gripping surface 16, 16′, more clearly shown in FIG. 2, includes wall sections 24, 24′ extending radially inwardly from the jaws 12, 14, respectively. The outer edges 26, 26′ of the wall sections 24, 24′, respectively, are adapted to substantially circumscribe and grip the outside surface of the work piece when the jaws 12, 14 are in the closed position.

The gripping surfaces 18, 18′, more clearly shown in FIG. 1, include wall sections 25, 25′ extending radially inwardly from the jaws 12, 14, respectively. A plurality of spaced apart fingers 28 extend radially inwardly from an outer edge 27, 27′ of the wall sections 25, 25′, respectively. The fingers 28 are adapted to contact and grip the outside surface of the work piece when the jaws 12, 14 are in the closed position.

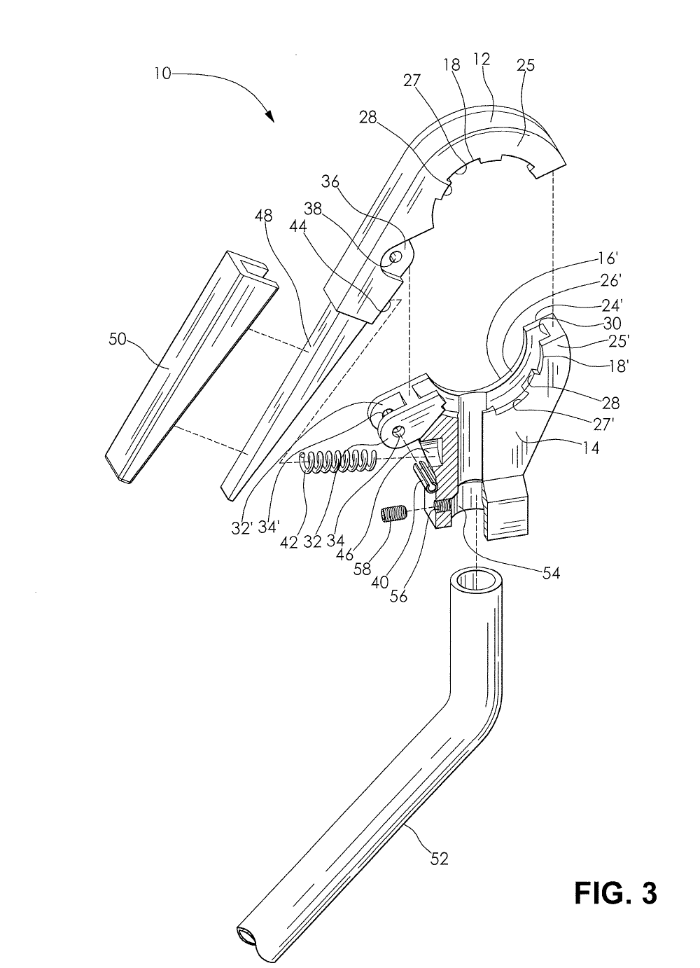

The jaw 14 includes a pair of spaced apart hinge members 32, 32′ extending from the jaw 14. The hinge members 32, 32′ include an aperture 34, 34′ formed therein. The hinge members 32, 32′ are adapted to receive a portion of the jaw 12 therebetween. The jaw 12 includes a recessed area 36, more clearly shown in FIG. 3, adapted to receive the hinge members 32, 32′ of the jaw 14. A hole 38 is formed to extend through the recessed area 36 of the jaw 12. The hole 38 is in alignment with the apertures 34, 34′ when the jaw 12 is positioned between the hinge members 32, 32′. A roll pin 40 is inserted in the apertures 34, 34′ and the hole 38 to pivotally interconnect the jaws 12, 14. It should be understood that other members can be employed to pivotally interconnect the jaws 12, 14 such as a threaded fastener or a rivet, for example.

A spring 42 is disposed between the jaws 12, 14 adjacent the location where the jaws 12, 14 are pivotally interconnected. Apertures 44, 46 are formed in the jaws 12, 14, respectively. One end of the spring 42 is inserted into the aperture 44 and an opposite end of the spring is inserted into the aperture 46. The spring 42 normally biases the jaws 12, 14 to a closed or work piece gripping position as illustrated in FIGS. 1 and 2. In the illustrated embodiment, the spring 42 is an elongate coil compression spring. It should be understood that other styles of springs can be used to bias the jaws 12, 14 in the closed clamping position.

A handle 48 extends from the jaw 12. In the embodiment shown, the handle is integrally formed with the jaw 12. The handle 48 includes a cushioning member 50 typically formed from a compliant material such as a sponge rubber or an elastomeric material

A rigid conduit 52, as clearly shown in FIG. 3, is attached to jaw 14. One end of the conduit is received within a bore 54 which extends through the jaw 14. The bore 54 extends through the jaw 14 into the annular channel 30 between the gripping surfaces 16, 16′ and 18, 18′. The conduit 52 cooperates with the handle 48 of the jaw 12 to facilitate the opening of the jaws 12, 14 by squeezing together the handle 48 and the conduit 52 which causes the jaws 12, 14 to pivot to an open position.

The conduit 52 and the bore 54 cooperate to provide a fluid communication path from a remote source of fluid to the annular channel 30. An internally threaded hole 56 is formed in the jaw 14 that extends into the bore 54. A cooperating threaded fastener 58 is provided that is received by the threaded hole 56 and adapted to retain the conduit 52 within the bore 54. It should be understood that a valve and a pressure regulator can be included in the communication path to facilitate controlling the flow rate of the fluid into the annular channel 30. Additionally, it should be understood that the conduit 52 can include a gas line quick connect coupling or other coupling means to connect the conduit 52 to the source of fluid.

In operation, the soldering device 10 is employed to form a fluid tight joint between a male end of one work piece that is inserted into a female end of another work piece. A user of the soldering device initially causes the jaws 12, 14 to open by squeezing together the handle 48 and conduit 52. Once the jaws 12, 14 are opened, the female end of one work piece is received between the jaws 12, 14 having the male end of the other work piece inserted therein. The user then releases the handle 48 and conduit 52 causing the jaws 12, 14 to return to the normally closed position and causing the gripping surfaces 16, 16′ and 18, 18′ of the jaws 12, 14 to contact the outer surface of the female end of the one work piece and secure the soldering device 10 thereto. Once the soldering device 10 is secured to the work piece, the user is relieved from the tiresome task of holding the soldering device 10 and providing relative motion between the soldering device 10 and the work piece. The user also has both hands free to apply the necessary solder to the joint between work pieces.

A fluid is caused to flow from the remote source of the fluid, through the conduit 52 and the bore 54, and into the annular channel 30. In the embodiment shown, the fluid is a gas which is caused to burn within the annular channel 30 adjacent the gripping surfaces 16, 16′ and 18, 18′ to supply the heat energy to the work pieces. It should be understood that the soldering device 10 can include an igniter to initially ignite the gas flowing into the annular channel 30. Other sources of heat energy may be employed such as electrical heating elements disposed adjacent to or directly on the gripping surfaces 16, 16′ and 18, 18′ for example.

The atmospheric oxygen required for the gas to burn flows into the annular channel 30 through the gaps formed between the spaced apart fingers 28. Additionally, the byproducts of the combusted gas exhaust from the annular channel 30 through the gaps formed between the spaced apart fingers 28.

Once sufficient heat energy has been applied to the work pieces, the user applies a solder to the male end of the work piece adjacent the female end being gripped by the soldering device 10. The heat energy causes the applied solder to melt and causes the molten solder to be drawn into the joint between the work pieces by capillary action. The jaws 12, 14 of the soldering device 10 are then opened to remove the soldering device from the work pieces. The user can repeat the process to solder together additional work pieces or stop the flow of gas to the annular channel 30, which will cause the flame therein to extinguish.

The flame from the burning gas is contained within the annular channel 30 which circumscribes the work pieces for the uniform delivery of heat energy to the work pieces and facilitates the formation of a leak free joint. Additionally, because the flame is contained within the annular channel 30, the risk of burning and melting items adjacent to the work pieces is reduced.

From the foregoing description, one ordinarily skilled in the art can easily ascertain the essential characteristics of this invention, and without departing from the spirit and scope thereof, can make various changes and modifications to the invention to adapt it to various usages and conditions.

What is claimed is:

1. A heating device for applying heat energy to the end of two work pieces to be joined comprising:
a pair of connected relatively moveable jaws, each of the jaws having a work piece gripping surface;
spring means normally maintaining the gripping surfaces in a work piece gripping position; and
means for delivering heat energy adjacent to the cooperating work piece gripping surfaces.

2. The heating device according to claim 1 wherein the jaws are pivotally connected.

3. The heating device according to claim 1 wherein at least one of the jaws includes a handle extending therefrom.

4. The heating device according to claim 3 wherein the handle includes a cushioning member disposed thereon adapted to facilitate a user of the device forming a secure grip on the handle.

5. The heating device according to claim 1, the gripping surfaces further comprising a first griping surface and a spaced apart second gripping surface forming a channel therebetween.

6. The heating device according to claim 5 wherein at least one of the first gripping surface and the second gripping surface includes a substantially continuous outer edge adapted to contact and grip an outer surface of the work piece when the jaws are in the work piece gripping position.

7. The heating device according to claim 5 wherein at least one of the first gripping surface and the second gripping surface includes a plurality of spaced apart fingers adapted to contact and grip an outer surface of the work piece when the jaws are in the work piece gripping position.

8. The heating device according to claim 2 wherein spring means includes a compression spring disposed between the jaws adjacent the location where the jaws are pivotally connected.

9. The heating device according to claim 5 wherein means for delivering heat energy includes a fluid communication path between a source of fluid and the channel formed between the first gripping surface and the second gripping surface.

10. The heating device according to claim 10, the communication path further comprising:
a bore formed in at least one of the jaws extending from an outer surface of the jaw to the annular channel formed between the first gripping surface and the second gripping surface; and
a conduit having one end received within the bore at the outer surface of the jaw, and a spaced apart opposite end in fluid communication with the source of fluid.

11. The heating device according to claim 10 wherein the fluid communication path includes at least one of a valve and a pressure regulator adapted to control a flow rate of the fluid therethrough.

12. The heating device according to claim 10 wherein the fluid is a flammable gas, the gas being burned within the annular channel adjacent to the gripping surfaces to provide heat energy to the work pieces.

13. The heating device according to claim 12 wherein an igniter is provided adjacent the gripping surfaces adapted to initiate the burning of the gas.

14. A heating device for applying heat energy to the end of two work pieces to be joined comprising:
a first jaw pivotally connected to a second jaw, the jaws cooperating to form a generally circular shaped first gripping surface and a spaced apart generally circular shaped second gripping surface, the gripping surfaces forming a substantially annular channel therebetween;
a compression spring disposed between the jaws adjacent the location where the jaws are pivotally connected, the spring adapted to maintain the gripping surfaces in a work piece gripping position; and
a fluid communication path from a source of flammable gas, through the second jaw, and into the annular channel formed between the first gripping surface and the second gripping surface, wherein the flammable gas is caused to burn within the annular channel adjacent the gripping surfaces to supply heat energy to the work pieces to be joined.

15. The heating device according to claim 14 wherein the first jaw includes a handle extending therefrom.

16. The heating device according to claim 14 wherein at least one of the first gripping surface and the second gripping surface includes a substantially continuous outer edge adapted to contact and grip an outer surface of the work piece when the jaws are in the work piece gripping position.

17. The heating device according to claim 14 wherein at least one of the first gripping surface and the second gripping surface includes a plurality of spaced apart fingers adapted to contact and grip an outer surface of the work piece when the jaws are in the work piece gripping position.

18. The heating device according to claim 14, the communication path further comprising:
a bore formed in the second jaw extending from an outer surface of the second jaw to the annular channel formed between the first gripping surface and the second gripping surface; and
a conduit having one end securely received within the bore at the outer surface of the second jaw, and a spaced apart opposite end in fluid communication with the source of gas.

19. The heating device according to claim 18 wherein the fluid communication path includes at least one of a valve and a pressure regulator adapted to control a flow rate of the gas therethrough.

20. The heating device according to claim 15 wherein an igniter is provided adjacent the gripping surfaces adapted to initiate the burning of the gas.
